(19) United States
(12) Patent Application Publication
(10) Pub. No.: US 2015/0002042 A1
(43) Pub. Date: Jan. 1, 2015

(54) POWER SUPPLY APPARATUS

(71) Applicant: SAMSUNG ELECTRO-MECHANICS CO., LTD., Suwon (KR)

(72) Inventors: Jae Kuk KIM, Suwon (KR); Sang Kyoo HAN, Daejeon (KR); Jin Sik PARK, Suwon (KR)

(73) Assignee: SAMSUNG ELECTRO-MECHANICS CO., LTD., Suwon (KR)

(21) Appl. No.: 14/043,314

(22) Filed: Oct. 1, 2013

(30) Foreign Application Priority Data
Jun. 26, 2013 (KR) 10-2013-0073608

(51) Int. Cl. H05B 33/08

(52) U.S. Cl. CPC H05B 33/0815
USPC 315/223

(57) ABSTRACT

There is provided a power supply apparatus supplying a power to an electronic device, especially, a light emitting diode, capable of stably supplying power to different loads with simple circuit configuration, and maintaining the balance of the current supplied to light emitting diodes.

### CROSS-REFERENCE TO RELATED APPLICATIONS

This application claims the priority of Korean Patent Application No. 10-2013-0073608 filed on Jun. 26, 2013, in the Korean Intellectual Property Office, the disclosure of which is incorporated herein by reference.

### BACKGROUND OF THE INVENTION

1. Field of the Invention

The present invention relates to a power supply apparatus supplying power to at least one light emitting diode.

2. Description of the Related Art

In general, a power supply apparatus is frequently used in information devices such as personal computers and home appliances such as air conditioners, audio systems and audio-visual devices.

Such a power supply apparatus may provide a plurality of output powers depending on the electronic devices to which such power supply apparatuses are applied.

A typical multiple-power supply apparatus converts an input direct current (DC) power into alternating current (AC) power using a single transformer, and rectifies the AC power so as to output a plurality of direct current power currents. In a typical multiple-power supply apparatus, however, if the voltage level of one of the plurality of direct current power is changed, it influences other direct current power so that cross-regulation is not maintained. To overcome the problem, a step-down chopper circuit is commonly used at the output stage. However, after primary power conversion, power conversion is made by the step-down chopper circuit once again, and thus the efficiency of power conversion is lowered. Further, adding the step-down chopper circuit increases the number of the components and thereby increases manufacturing costs.

Especially when a power supply apparatus is used for driving light emitting diodes, a step-up or step-down circuit is employed for compensating for voltage deviations between the light emitting diodes after the primary power conversion as disclosed in Patent Document 1. Therefore, the efficiency of power conversion is lowered, and adding such a step-up or step-down chopper circuit increases the number of required components, thereby increasing manufacturing costs.

### RELATED ART DOCUMENT

(Patent Document 1) Korean Patent Laid-open Publication No. 10-2007-0068804

### SUMMARY OF THE INVENTION

An aspect of the present invention provides a power supply apparatus supplying power to an electronic device, especially a light emitting diode, capable of stably supplying power to different loads with a simple circuit configuration, and maintaining the balance of the current supplied to light emitting diodes.

According to an aspect of the present invention, there is provided a power supply apparatus including: a power supplying unit switching an input power so as to supply at least two powers; a first control unit controlling primary side switching of the power supplying unit in a predetermined first manner according to the state of one of the at least two powers from the power supplying unit; a current balancing unit receiving another of the least two powers from the power supplying unit and maintaining the balance of currents between at least two light emitting diodes so as to transfer the power; and a second control unit controlling secondary side switching of the power supplying unit in a predetermined second manner according to the state of the power transferred to the least one light emitting diode of the at least two light emitting diodes.

The first control unit may control the primary side switching frequency of the power supplying unit.

The second control unit may control the secondary side switching duty of the power supplying unit.

The power supplying unit may include: a power switching unit switching the input power under the control of the first control unit; a transformer having a primary winding receiving the switched powers from the switching units, and a plurality of secondary windings magnetically coupled to the primary winding to have a predetermined turns ratio; and a switching unit connected to one of the plurality of secondary windings and switching the transferred power under the control of the second control unit to supply the switched power to the current balancing unit.

The plurality of secondary windings of the transformer may be made up of: a first secondary winding group having some of the plurality of secondary windings and supplying power to the light emitting diodes; and a second secondary winding group having the other of the plurality of secondary windings.

The current balancing unit may include: a diode group having a plurality of diodes each connected between both ends of a secondary winding of the first secondary winding group so as to provide a power transfer path; and capacitors respectively located between one diode of the diode group and a corresponding secondary winding so as to maintain the balance of currents flowing in one direction and the other direction of the corresponding secondary winding.

Each of the at least two light emitting diodes may be connected to one end of each of the first secondary winding group via at least one diode of the diode group, or to the other terminal of each of the capacitors with one terminal connected to the other end of each of the secondary windings.

The first control unit may include: a power control unit controlling the switching of the power supplying unit according to the output state of at least one of the powers from the power supplying unit; a frequency control unit controlling the switching frequency of the power supplying unit according to the switching control of the power control unit; and a gate driver driving the switching of the power switching unit according to the switching frequency of the frequency control unit.

The first control unit may further include a transfer unit which has one side to receive a signal and the other side to transmit a signal, electrically isolated from each other, so that the control signal from the power control unit input to the one side is transmitted to the frequency control unit connected to the other side.

The second control unit may include: a PI control unit comparing a current value flowing in one of the at least two light emitting diodes with a command current value; and a switching control unit comparing the comparison result from the PI control unit with a predetermined reference signal so as to control the switching duty of the switching unit.

According to another aspect of the present invention, there is provided a power supply apparatus including: a power supplying unit switching an input power to supply a predetermined power; and a current balancing unit alternately supplying the power from the power supplying unit to at least two light emitting diodes according to the switching of the power supplying unit so as to maintain the balance of currents between the at least two light emitting diodes.

The first secondary winding group may include N secondary windings, wherein N is a natural number equal to or greater than 1, and the other end of each of the N secondary windings is connected to one end of and adjacent secondary winding via at least one diode of the diode group so as to supply power to (N+1) light emitting diodes.

### BRIEF DESCRIPTION OF THE DRAWINGS

The above and other aspects, features and other advantages of the present invention will be more clearly understood from the following detailed description taken in conjunction with the accompanying drawings, in which:

FIG. 1 is a schematic circuit diagram of a power supply apparatus according to an embodiment of the present invention;

FIG. 2 is a circuit diagram schematically showing the current balancing unit employed in the power supply apparatus according to the embodiment of the present invention;

FIGS. 3 and 4 are circuit diagrams illustrating the operation of the current balancing unit employed in the power supply apparatus according to the embodiment of the present invention;

FIGS. 5A to 5C are circuit diagrams illustrating various examples of the current balancing unit employed in the power supply apparatus according to the embodiment of the present invention;

FIG. 6 is a circuit diagram illustrating the power supply apparatus according to the embodiment of the present invention in more detail;

FIG. 7 is a graph showing operation waveforms of the power supply apparatus; and

FIG. 8 to FIG. 10 are graphs showing voltage or current waveforms of main components of the power supply apparatus according to the embodiment of the present invention.

### DETAILED DESCRIPTION OF THE INVENTION

Hereinafter, embodiments of the present invention will be described in detail. The invention may, however, be embodied in many different forms and should not be construed as being limited to the embodiments set forth herein. Rather, these embodiments are provided so that this disclosure will be thorough and complete, and will fully convey the scope of the invention to those skilled in the art. Throughout the drawings, the same or like reference numerals will be used to designate the same or like elements.

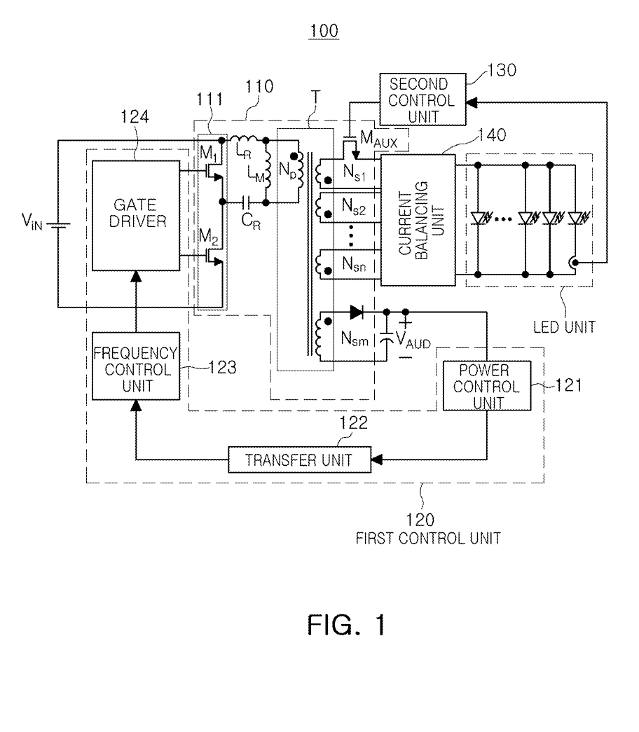

FIG. 1 is a schematic circuit diagram of a power supply apparatus according to an embodiment of the present invention.

Referring to FIG. 1, the power supply apparatus 100 according to the embodiment may include a power supplying unit 110, a first control unit 120, a second control unit 130, and a current balancing unit 140.

The power supplying unit 110 may include a power switching unit 111 switching an input power and a transformer T.

The power switching unit 111 may include power switches M1 and M2 switching an input power, and the power switches M1 and M2 may perform power-conversion by alternately switching the input power according to control.

The transformer T may include a primary winding Np and at least two secondary windings Ns1 to Nsn and Nsm.

The primary winding Np receives the power switched by the power switching unit. The at least two secondary windings Ns1 to Nsn and Nsm are electrically isolated from and magnetically coupled to the primary winding Np to have predetermined turns ratios, such that power input to the primary winding Np is converted according to the turns ratios so as to be output.

The at least two secondary windings Ns1 to Nsn and Nsm may be divided into a first secondary winding group Ns1 to Nsn and a second secondary winding group Nsm.

The first secondary winding group Ns1 to Nsn may include at least one secondary winding, and may include a plurality of secondary windings if a plurality of light emitting diodes were employed. Each secondary winding of the first secondary winding group Ns1 to Nsn may supply power to a light emitting diode in a LED unit, and the second secondary winding group Nsm including at least one secondary winding may supply power necessary for operating an electronic device including alight emitting diode. The power supplied to electronic devices may be output from the second secondary winding group Nsm, stabilized by a diode and capacitor, and then supplied.

The first control unit 120 may control the power switches M1 and M2 of the power switching unit in a predetermined manner according to the power condition of the power supplied to the electronic device from the second secondary winding group Nsm. Specifically, the first control unit 120 may control the switching frequencies of the switches according to the power condition.

To this end, the first control unit 120 may include a power control unit 121, a transfer unit 122, a frequency control unit 123, and a gate driver 124.

The power control unit 121 may provide a control signal controlling the switching of the power switches M1 and M2 according to the power condition. The transfer unit 122 is configured as an isolated element such as a photo coupler or an isolated transformer since the primary winding Np and the secondary windings Ns1 to Nsn and Nsm are electrically isolated as mentioned above, so that the control signal from the power control unit 121 on the secondary side may be transferred to the frequency control unit 123 on the primary side.

The frequency control unit 123 may provide a control signal for controlling the switching frequencies of the power switches M1 and M2 based on the control signal from the transfer unit 122. The gate driver 124 may provide a driving signal for driving the power switches M1 and M2 based on the control signal from the frequency control unit 123.

The second control unit 130 may control the supply of power by the first secondary winding group Ns1 to Nsn in a predetermined control manner. Specifically, the second control unit 130 may control the switching duty of the power transferred via the first secondary winding group Ns1 to Nsn. To this end, the power supplying unit 110 may further include a switching unit switching the power transferred via the first secondary winding group Ns1 to Nsn. The switching unit may include a switch M_{AUX} that is connected to one of the first secondary winding group Ns1 to Nsn and switches the power according to the switching control by the second control unit 130.

The current balancing unit 140 may maintain balance of current in the power transferred to a light emitting diode via the first secondary winding group Ns1 to Nsn.

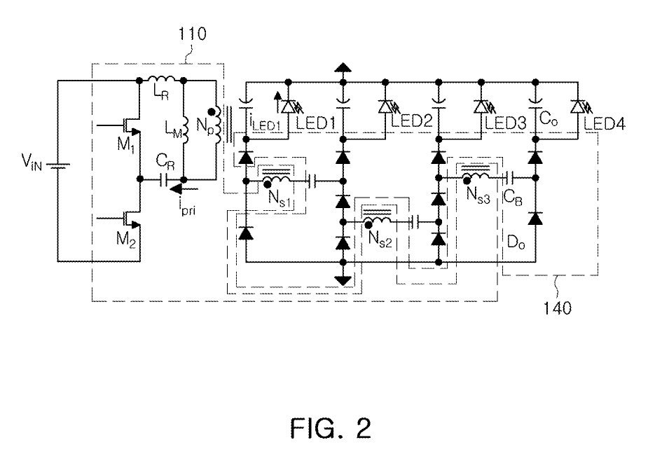

FIG. 2 is a circuit diagram schematically showing the current balancing unit employed in the power supply apparatus according to the embodiment of the present invention.

Referring to FIG. 2, the current balancing unit 140 employed in the power supply apparatus according to the embodiment may include a diode group having a plurality of diodes and a capacitor connected to the secondary winding.

For example, when first to fourth light emitting diodes LED1, LED2, LED3 and LED4 are powered to be driven, the first second winding group may include the first to third windings Ns1, Ns2, and Ns3, and a current may flow while alternating in the current directions from one end to the other end of the first to third secondary windings Ns1 to Ns3, and vice versa, according to the switching of the power supplying unit 110. Here, the power supplying unit 110 may include a LLC (inductor-inductor-capacitor) resonant converter.

Each of the first to third secondary windings Ns1 to Ns3 may share a light emitting diode, to which they supply power, with the adjacent secondary winding, and thus may drive four light emitting diodes with three secondary windings. However, the number of the secondary windings and that of the light emitting diodes are not limited to the above numbers. Two light emitting diodes may be driven with one secondary winding, and N+1 light emitting diodes may be powered with N secondary windings to be driven, where N is a natural number equal to or greater than “1.”

The diode group having a plurality of diodes may provide a transfer path of the power transferred from the first to third winding Ns1 to Ns3 to the light emitting diodes LED1 to LED4. A capacitor may be connected between one of the secondary windings and a corresponding diode to maintain the balance of current according to the charge balance law.

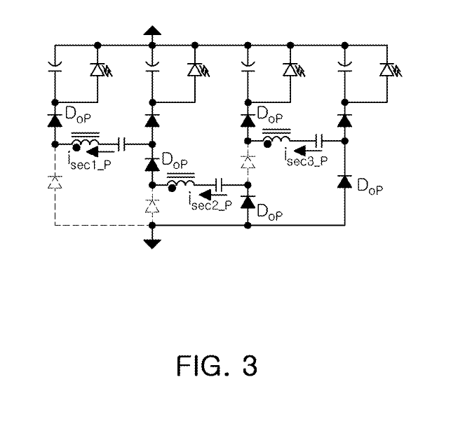

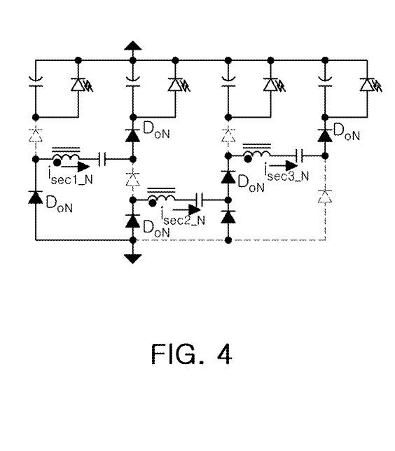

FIGS. 3 and 4 are circuit diagrams illustrating the operation of the current balancing unit employed in the power supply apparatus according to the embodiment of the present invention.

Referring to FIG. 3 in conjunction with FIG. 2, currents isec1_P, isec2_P and isec3_P may flow in the first to third secondary windings Ns1 to Ns3, respectively, in the direction from the other end to the one end thereof, and a corresponding diode DoP may be turned on so that the currents isec1_P, isec2_P and isec3_P flowing the direction may be transmitted to the corresponding light emitting diodes LED1 and LED3.

Referring to FIG. 4 in conjunction with FIG. 2, currents isec1_N, isec2_N and isec3_N may flow in the first to third secondary windings Ns1 to Ns3, respectively, in the direction from the one end to the other end thereof, and a corresponding diode DoN may be turned on so that the currents isec1_N, isec2_N and isec3_N flowing the direction may be transmitted to the corresponding light emitting diodes LED2 and LED4.

The above-described operation of supplying power will be described with respect to current balance along with the switching of the power supplying unit 110. When the second power switch M2 is turned on, a current conduction path as shown in FIG. 3 is made, so that Equation 1 maybe established as follows:

(Equation 1)

I_{sec}_{_{—}}_{P}_{_{—}}₁=I_{sec}_{_{—}}_{P}_{_{—}}₂=I_{LED1}, I_{sec}_{_{—}}_{P}_{_{—}}₃=I_{LED3} (1).

Next, when the first power switch M1 is turned on, a current conduction path as shown in FIG. 4 is made, so that Equation 2 may be established as follows:

(Equation 2)

I_{sec}_{_{—}}_{N}_{_{—}}₁−I_{LED2}, I_{sec}_{_{—}}_{N}_{_{—}}₂−I_{sec}_{_{—}}_{N}_{_{—}}₃−I_{LED4} (2).

Here, due to charge balance law of capacitors connected the other end of the first to third secondary windings Ns1 to Ns3, the average value of the DC offset in currents is removed, and thereby Equation 3 may be established as follows:

(Equation 3)

I_{sec}_{_{—}}_{P}_{_{—}}₁=I_{sec}_{_{—}}_{N}_{_{—}}₁, I_{sec}_{_{—}}_{P}_{_{—}}₂=I_{sec}_{_{—}}_{N}_{_{—}}₂, I_{sec}_{_{—}}_{P}_{_{—}}₃=I_{sec}_{_{—}}_{N}_{_{—}}₃ (3).

Finally, as shown in Equation 4, the current values transferred to the first to fourth light emitting diodes LED1 to LED4 may be controlled so that they are the same, which may be equally applied to N light emitting diodes.

<I_{sec}_{_{—}}_{P}_{_{—}}₁>=<I_{sec}_{_{—}}_{N}_{_{—}}₁>= . . . =<I_{sec}_{_{—}}_{P}_{_{—}}ₙ>=<I_{sec}_{_{—}}_{N}_{_{—}}ₙ>=I_{LED1}=I_{LED2}= . . . =I_{LEDn} (4).

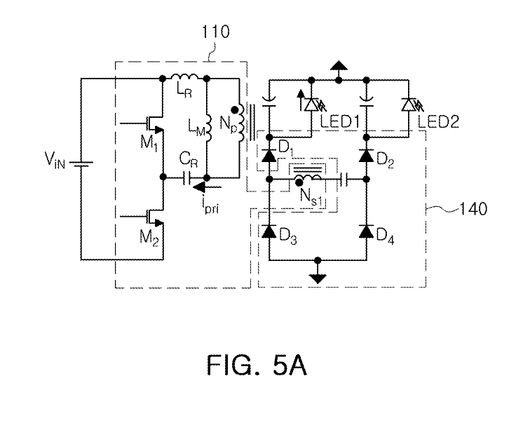

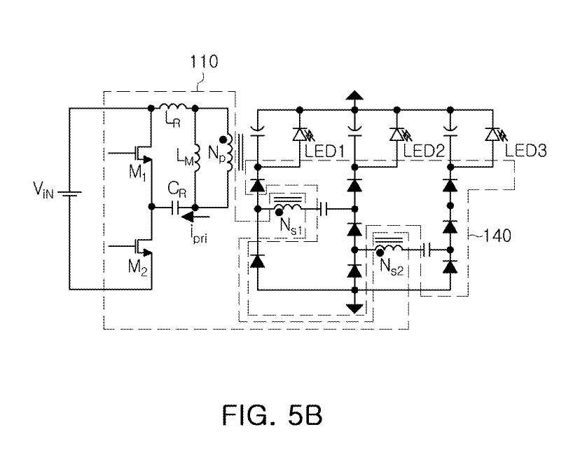

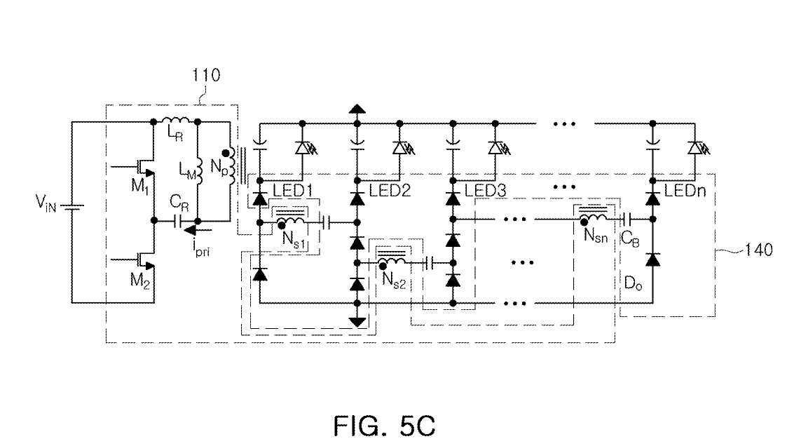

FIGS. 5A to 5C are circuit diagrams illustrating various examples of the current balancing unit employed in the power supply apparatus according to the embodiment of the present invention.

Referring to FIGS. 5A to 5C, as shown in FIG. 5A, two light emitting diodes LED1 and LED2 may be powered to be driven with one secondary winding Ns1, and current balance is maintained between the two light emitting diodes LED1 and LED2.

Likewise, as shown in FIG. 5B, three light emitting diodes LED1, LED2 and LED3 may be powered to be driven with two secondary windings Ns1 and Ns2, or as shown in FIG. 5C, N+1 light emitting diodes LED1, LED2, LED3, . . . , LEDn+1 may be powered to be driven with N secondary windings Ns1, Ns2, . . . , Nsn, where N is a natural number equal to or greater than 1, such that current balance may be made maintained among three light emitting diodes LED1, LED2 and LED3 or N+1 light emitting diodes LED1, LED2, LED3, . . . , LEDn+1.

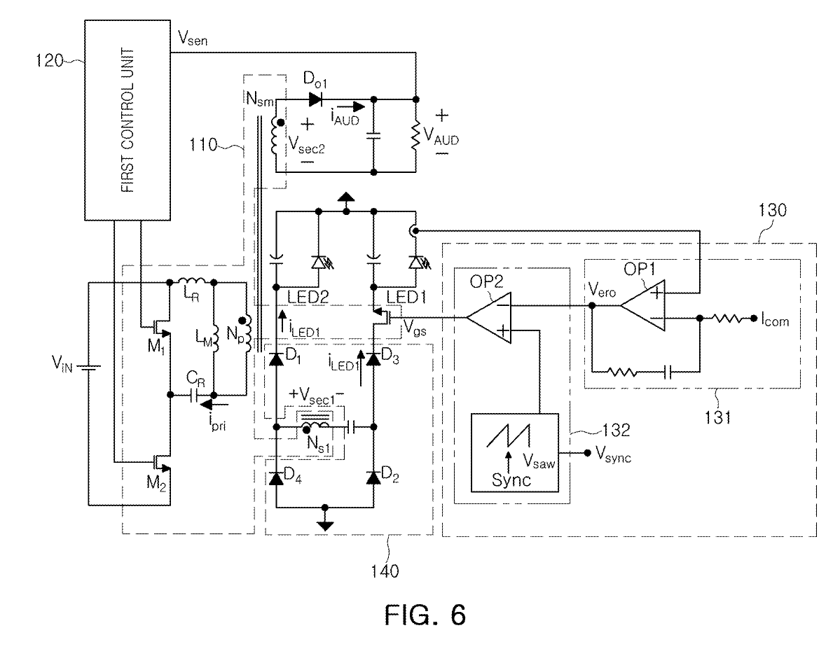

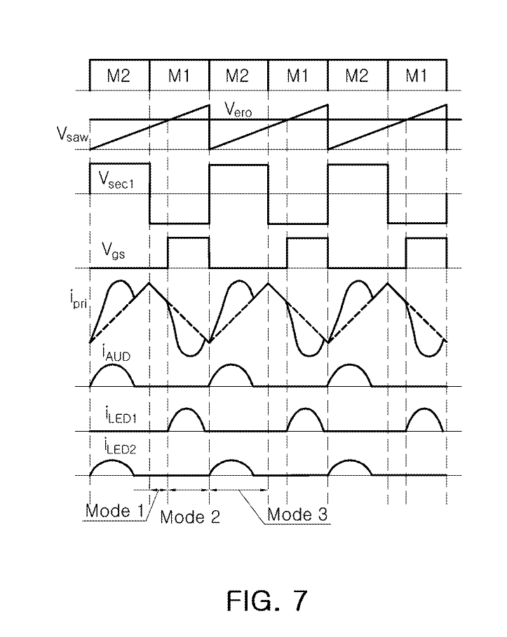

FIG. 6 is a circuit diagram illustrating the power supply apparatus according to the embodiment of the present invention in more detail, and FIG. 7 is a graph showing operation waveforms of the power supply apparatus. For the sake of easy explanation of the overall system operation, FIGS. 6 and 7 illustrate the configurations and the operation waveforms of the simplest example, a single power stage power converter for a two-channel LED backlight.

Referring to FIG. 6, the power supply apparatus 100 according to the embodiment may control the switching frequency of a primary side power switching based on the output of the second secondary winding group, and may control the switching duty of a secondary side power switching based on the output of the first secondary winding group.

To this end, the second control unit 130 may include a PI control unit 131 having a comparator OP1 and a switching control unit 132 having a comparator OP2.

The PI control unit 131 may compare a current value flowing in a light emitting diode with a command current value indicating a current value intended to flow in the light emitting diode, to provide the result Vero.

The switching control unit 132 may compare the result Vero from the PI control unit 131 with a reference signal Vsaw of a predetermined triangular wave, to provide a control signal Vgs for controlling the switching duty of the switch M_{AUX} of the power supplying unit 110.

Referring to FIG. 7, the output V_{AUD} from the second secondary winding group may alternately turn on and off the power switches M1 and M2 by the first control unit 110. Here, the power switches M1 and M2 are controlled by the pulse frequency modulation (PFM) operation in which the operation frequency is varied while the duty ratio is fixed at 50%. Further, the current in the first light emitting diode LED1 is controlled by pulse width modulation (PWM) operation in which the duty ratio of the switch M_{AUX} is varied by the PI control unit 131 and the switching control unit 132. That is, the current in the first light emitting diode LED1, one of the light emitting diode channels, is detected using a resistance sensor or current sensor, and then is input to the PI control unit 131, such that the result voltage Vero is adjusted so that the current in the input first light emitting diode LED1 is equalized with the command current Icom. The result voltage Vero output from the PI control unit 131 is input to the switching control unit 132, and is compared to a reference signal having a lamp-waveform Vsaw generated by an external signal Vsync, so that the duty ratio of the generated control signal Vgs is varied, to thereby control the current flowing in the first light emitting diode LED1.

The operating principle of each of the modes according to switching states shown in FIG. 7 will be described.

Mode 1: the first power switch M1 is turned on and a positive (+) voltage is applied to a non-dot of the transformer, and thus the voltage Vsec1 at the first secondary winding has a negative (−) value, such that diodes Do1, D1 and D2 of the diode group are all turned off, and both of the output from the second secondary winding group i_{AUD} and the current i_{LED2} flowing in the second light emitting diode become zero. In addition, although a conduction path is made toward the first light emitting diode LED1 via the diodes D₃ and D₄, the current i_{LED1} in first light emitting diode does not flow either since the switch M_{AUX} is in the off state.

Mode 2: like Mode 1, the first power switch M1 is turned on, and the positive (+) voltage is applied to the Non-dot of the transformer, such that the voltage at the first secondary winding Vsec1 has the negative (−) value. When a control signal Vgs is applied to the switch M_{AUX}, a current flows in the first light emitting diode LED1 via a path of the switch M_{AUX} and the diodes D₃ and D₄, such that the current iLED1 in the first light emitting diode is controlled so that it becomes the command current Icom. At the same time, the voltage Vsec2 at the second secondary winding group also has the negative value, such that the diode Do1 is blocked, and thus no current flow toward the output i_{AUD} of the second secondary winding group.

Mode 3: when the first power switch M1 is turned off and the second power switch M2 is turned on, the positive (+) voltage is applied to Dot of the transformer. Accordingly, the voltage at the second secondary winding group Vsec2 has a positive value and thus the diode Do1 is turned on, such that the output current i_{AUD} from the second secondary winding group flows toward the output, to output an output voltage VAUD as shown in FIG. 7. At the same time, toward the light emitting diodes, the first secondary winding voltage Vsec1 has a positive value and the diodes D1 and D2 are turned on, such that current i_{LED2} flows in the second light emitting diodes LED2. At this time, by the capacitor C_{B}, the average current having the same amplitude as the current I_{LED1} flowing toward the first light emitting diode LED1 in Mode 2 flows toward the second light emitting diode LED2 as the current i_{LED2} such that the same average currents flow in the first light emitting diode LED1 and the second light emitting diode LED2 and thereby current balancing is achieved.

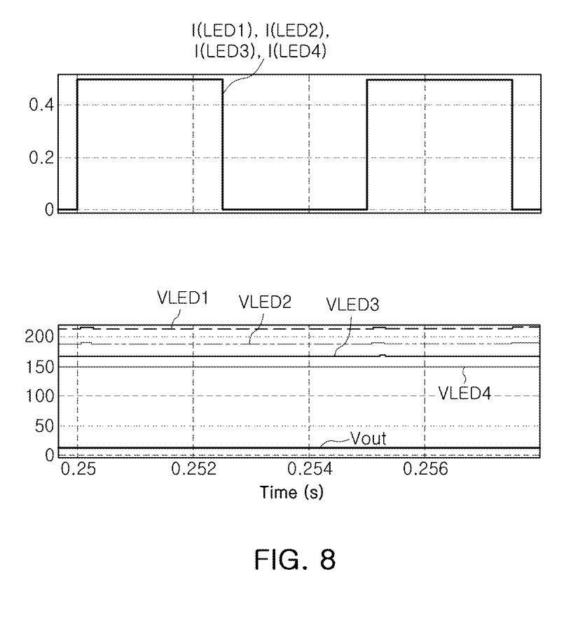

FIG. 8 to FIG. 10 are graphs showing voltage or current waveforms of main components of the power supply apparatus according to the embodiment of the present invention. The input/output specifications used in the experiment are: input voltage Vin=400 Vdc, VAUD=13V/2.5 A, output LED=4 channels/RLED (LED equivalent resistance)=428 ohm, 375 ohm, 333 ohm, 300 ohm, and PWM dimming frequency=200 Hz. Here, in order to exhibit current balancing performance of light emitting diodes, the equivalent resistance of each of the light emitting diodes are differently set as shown in FIG. 8.

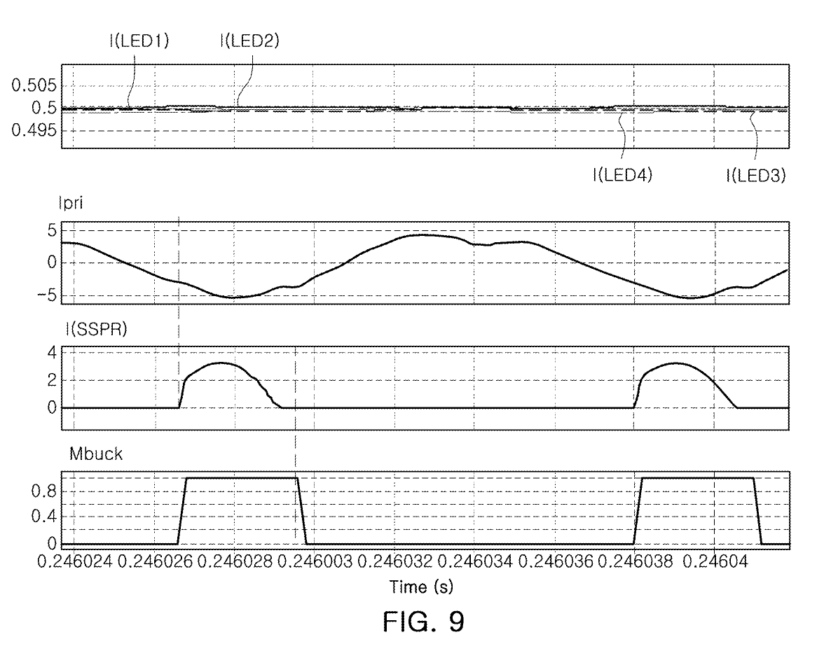

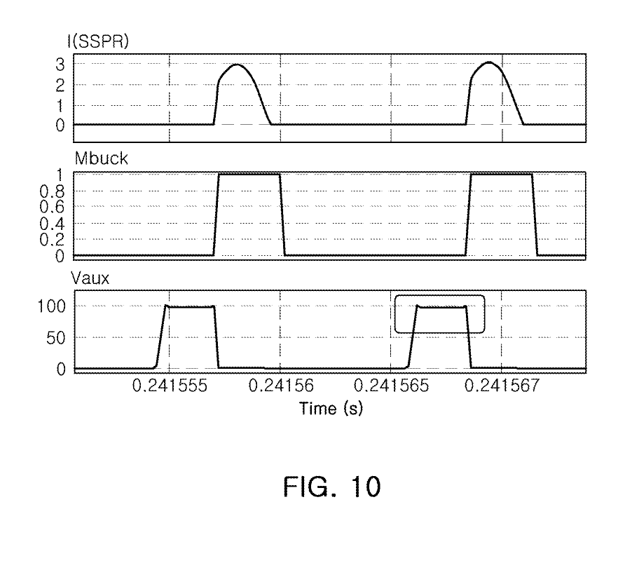

Even though the equivalent resistance of each of the light emitting diodes are different such that different voltages are applied as shown in FIG. 8, the current balances in each of the light emitting diodes are constantly maintained as shown in FIGS. 9 and 10.

As set forth above, according to embodiments of the present invention, power can be stably supplied to different loads and the area of the circuit and manufacturing cost can be reduced by a single power stage of the transformer and by the primary side switching between different loads and the switching of one of the plurality of secondary windings. Further, the balance of the current supplied to light emitting diodes can be maintained and the area of the circuit and manufacturing cost can be further reduced by the connection of the plurality of secondary windings and capacitors.

While the present invention has been shown and described in connection with the embodiments, it will be apparent to those skilled in the art that modifications and variations can be made without departing from the spirit and scope of the invention as defined by the appended claims.

What is claimed is:

1. A power supply apparatus comprising:
a power supplying unit switching an input power so as to supply at least two powers;
a first control unit controlling primary side switching of the power supplying unit in a predetermined first manner according to the state of one of the at least two powers from the power supplying unit;
a current balancing unit receiving another of the least two powers from the power supplying unit and maintaining the balance of currents between at least two light emitting diodes so as to transfer the power; and
a second control unit controlling secondary side switching of the power supplying unit in a predetermined second manner according to the state of the power transferred to the least one light emitting diode of the at least two light emitting diodes.

2. The apparatus of claim 1, wherein the first control unit controls the primary side switching frequency of the power supplying unit.

3. The apparatus of claim 1, wherein the second control unit controls the secondary side switching duty of the power supplying unit.

4. The apparatus of claim 1, wherein the power supplying unit includes:
a power switching unit switching the input power under the control of the first control unit;
a transformer having a primary winding receiving the switched powers from the switching units, and a plurality of secondary windings magnetically coupled to the primary winding to have a predetermined turns ratio; and
a switching unit connected to one of the plurality of secondary windings and switching the transferred power under the control of the second control unit so as to transfer the switched power to the current balancing unit.

5. The apparatus of claim 4, wherein the plurality of secondary windings of the transformer is made up of:
a first secondary winding group having some of the plurality of secondary windings and supplying power to the light emitting diodes; and
a second secondary winding group having the other of the plurality of secondary windings.

6. The apparatus of claim 5, wherein the current balancing unit includes:
a diode group having a plurality of diodes each connected to both ends of a secondary winding of the first secondary winding group so as to provide a power transfer path; and
capacitors respectively located between one diode of the diode group and a corresponding secondary winding so as to maintain the balance of currents flowing in one direction and the other direction of the corresponding secondary winding.

7. The apparatus of claim 6, wherein each of the at least two light emitting diodes is connected to one end of each of the first secondary winding group via at least one diode of the diode group, or to the other terminal of each of the capacitors with one terminal connected to the other end of each of the secondary windings.

8. The apparatus of claim 4, wherein the first control unit includes:
a power control unit controlling the switching of the power supplying unit according to the output state of at least one of the powers from the power supplying unit;
a frequency control unit controlling the switching frequency of the power supplying unit according to the switching control of the power control unit; and
a gate driver driving the switching of the power switching unit according to the switching frequency of the frequency control unit.

9. The apparatus of claim 8, wherein the first control unit further includes a transfer unit which has one side to receive a signal and the other side to transmit a signal, electrically isolated from each other, so that the control signal from the power control unit input to the one side is transmitted to the frequency control unit connected to the other side.

10. The apparatus of claim 4, wherein the second control unit includes:
a PI control unit comparing a current value flowing in one of the at least two light emitting diodes with a command current value; and
a switching control unit comparing the comparison result from the PI control unit with a predetermined reference signal so as to control the switching duty of the switching unit.

11. A power supply apparatus comprising:
a power supplying unit switching an input power to supply a predetermined power; and
a current balancing unit alternately supplying the power from the power supplying unit to at least two light emitting diodes according to the switching of the power supplying unit so as to maintain the balance of currents between the at least two light emitting diodes.

12. The apparatus of claim 11, wherein the power supplying unit includes:
a power switching unit switching the input power according to control;
a transformer having a primary winding receiving the switched powers from the switching units, and a plurality of secondary windings magnetically coupled to the primary winding to have a predetermined turns ratio; and
a switching unit connected to one of the plurality of secondary windings and switching the transferred power according to control so as to transfer the switched power to the current balancing unit.

13. The apparatus of claim 12, wherein the plurality of secondary windings of the transformer is made up of:
a first secondary winding group having some of the plurality of secondary windings and supplying power to the at least two light emitting diodes; and
a second secondary winding group having the other of the plurality of secondary windings.

14. The apparatus of claim 13, wherein the current balancing unit includes:
a diode group having a plurality of diodes each connected between both ends of a secondary winding of the first secondary winding group so as to provide a power transfer path; and
capacitors respectively located between one diode of the diode group and a corresponding secondary winding so as to maintain the balance of currents flowing in one direction and the other direction of the corresponding secondary winding.

15. The apparatus of claim 14, wherein each of the at least two light emitting diodes is connected to one end of each of the first secondary winding group via at least one diode of the diode group, or to the other terminal of each of the capacitors with one terminal connected to the other end of each of the secondary windings, so as to receive the power.

16. The apparatus of claim 15, wherein the first secondary winding group includes N secondary windings, wherein N is a natural number equal to or greater than 1, and the other end of each of the N secondary windings is connected to one end of and adjacent secondary winding via at least one diode of the diode group so as to supply power to (N+1) light emitting diodes.

17. The apparatus of claim 13, further comprising:
a first control unit controlling primary side switching of the power supplying unit in a predetermined first manner according to the state of one of the at least two powers from the power supplying unit; and
a second control unit controlling secondary side switching of the power supplying unit in a predetermined second manner different from the first manner according to the state of the power transferred to at least one light emitting diode of the at least two light emitting diodes.

18. The apparatus of claim 17, wherein the second control unit controls the secondary side switching duty of the power supplying unit.

19. The apparatus of claim 17, wherein the first control unit includes:
a power control unit controlling the switching of the power supplying unit according to the output state of at least one of the powers from the power supplying unit;
a frequency control unit controlling the switching frequency of the power supplying unit according to the switching control of the power control unit; and
a gate driver driving the switching of the power switching unit according to the switching frequency of the frequency control unit.

20. The apparatus of claim 17, wherein the second control unit includes:
a PI control unit comparing a current value flowing in one of the at least two light emitting diodes with a command current value; and
a switching control unit comparing the comparison result from the PI control unit with a predetermined reference signal so as to control the switching duty of the switching unit.
